(19) United States
(12) Patent Application Publication
(10) Pub. No.: US 2019/0267595 A1
(43) Pub. Date: Aug. 29, 2019

(54) SEPARATOR AND LITHIUM ION BATTERY

(71) Applicant: NINGDE AMPEREX TECHNOLOGY LIMITED, Ningde (CN)

(72) Inventors: Gengjin KONG, Ningde (CN); Dongyang Guo, Ningde (CN); Xinghua Tao, Ningde (CN)

(21) Appl. No.: 16/178,406

(22) Filed: Nov. 1, 2018

(30) Foreign Application Priority Data
Feb. 28, 2018 (CN) 201810165887.8

(51) Int. Cl. H01M 2/16; H01M 10/0525

(52) U.S. Cl. CPC H01M 2/166; H01M 10/0525; H01M 2/162

(57) ABSTRACT

The present disclosure provides a separator and a lithium ion battery. The separator includes a porous substrate; and a porous layer disposed on at least one surface of the porous substrate. The porous layer includes inorganic particles and a binder, and an iron content in the porous layer is not more than 2100 ppm.

### CROSS-REFERENCE TO RELATED APPLICATION

This application claims priority to and benefits of Chinese Patent Application Serial No. 201810165887.8, filed with the State Intellectual Property Office of P. R. China on Feb. 28, 2018, and the entire content of which is incorporated herein by reference.

### FIELD

The present disclosure relates to the field of batteries, and more particularly to a separator and a lithium ion battery having the same.

### BACKGROUND

With the popularization of products like electronic devices and electric vehicles, lithium ion batteries need to possess high security and reliability in addition to high energy density. A separator, as an important part of the lithium-ion battery, has an important impact on the electrochemical performance and security of the lithium-ion battery. However, the existing separators have some safety problems to a certain extent, such as the occurrence of rupture or short circuit, and even cause fire and explosion.

Therefore, the current technology related to the separator needs to be improved.

### SUMMARY

Embodiments of the present disclosure seek to solve at least one of the problems existing in the related art to at least some extent. For this, embodiments of the present disclosure provide a separator with a low iron content, which can prevent a porous substrate from being punctured by iron particles to cause short circuit, and give a lithium ion battery produced therefrom a low self-discharge rate, a good security or a good cycle performance.

In embodiments of a first aspect of the present disclosure, a separator is provided. The separator includes: a porous substrate; and a porous layer disposed on at least one surface of the porous substrate. An iron content in the porous layer is not more than 2100 ppm.

In embodiments of the present disclosure, the iron content in the porous layer is not more than 1000 ppm.

In embodiments of the present disclosure, the porous layer includes inorganic particles and a binder, and the inorganic particles have a Moh's hardness of 0.5 to 8.

In embodiments of the present disclosure, the inorganic particles include one or more selected from titanium dioxide, silica, magnesium oxide, boehmite, aluminum hydroxide, magnesium hydroxide and barium sulfate.

In embodiments of the present disclosure, the binder includes one or more selected from the group of polyamide, polyacrylonitrile, polyacrylic ester, polyacrylic acid, polyacrylate, carboxymethylcellulose sodium, aramid fiber, polyvinylpyrrolidone, polyvinylidene fluoride, polytetrafluoroethylene, polyhexafluoropropylene, vinylidene fluoride-hexafluoropropylene copolymer, acrylic acid-acrylate copolymer, epoxy resin, polyurethane, polyvinylether and styrene butadiene rubber.

In embodiments of the present disclosure, based on a total mass of the porous layer, a mass percent of the inorganic particles is in a range of 40 wt % to 99.9 wt %.

In embodiments of the present disclosure, the porous layer has a thickness of 0.1 to 12 μm.

In embodiments of the present disclosure, the porous substrate includes one or more selected from the group of polyethylene, polypropylene, polyethylene terephthalate, polyimide and aramid fiber.

In embodiments of the present disclosure, the porous substrate has a thickness of 1 to 30 μm.

In embodiments of a second aspect of the present disclosure, a lithium ion battery is provided. The lithium ion battery includes the separator as described above.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawing, in which:

FIG. 1 is a schematic diagram of a separator according to embodiments of the present disclosure; and

FIG. 2 is a schematic diagram of a separator according to embodiments of the present disclosure.

### REFERENCE NUMERALS

100: porous substrate;
200: porous layer.

### DETAILED DESCRIPTION

In the following, the present disclosure will be described in detail with reference to examples. It should be appreciated to those skilled in the art that, the examples described below are explanatory, illustrative, and only used to generally understand the present disclosure, and shall not be construed to limit the present disclosure. Examples which do not indicate specific techniques or conditions are carried out in accordance with either the descriptions in literatures in the related art or the product specifications. Reagents or instruments whose manufacturers are not indicated are conventional products, which are commercially available.

The present disclosure is achieved on the basis of the following discoveries of inventors:

Separators of existing lithium ion batteries have a low melting point and poor thermal stability. In order to improve the thermal stability of the separator, researchers proposed to coat a porous layer on at least one surface of the separator. Although this operation could somewhat improve the thermal stability of the separator, the inventor found through experiments that a lithium ion battery using this separator is still prone to short-circuit, and even cause fire and explosion. In view of this, the inventors of the present disclosure carried out intensive researches, and surprisingly found out through massive experiments and accumulations that, it was the high hardness of aluminium oxide inorganic particles in the porous layer of the separator that finally results in the above problems. In the production process of the lithium ion battery, the aluminium oxide inorganic particles in a coating slurry will rub against a production equipment (its material is iron) to result in the formation of iron particles, which enter into the porous layer to lead to the iron particles in the porous layer of the separator beyond a certain content. In virtue of higher Moh's hardness (ranging from 4 to 8) and sharp shape, it is inevitable that the excessive iron particles will puncture the separator to cause short circuit, even worse to cause the fire and explosion.

In embodiments of a first aspect of the present disclosure, a separator is provided.

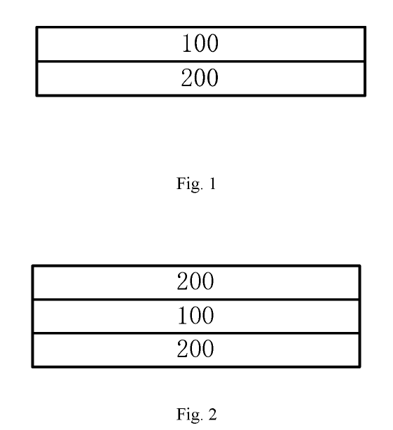

Referring to FIG. 1 and FIG. 2, the separator includes: a porous substrate 100; and a porous layer 200 disposed on at least one surface of the porous substrate 100. The porous layer 200 includes inorganic particles and a binder. An iron content in the porous layer 200 is not more than 2100 ppm. The inventor found that, the separator has a low iron content, which can avoid the porous substrate 100 of the separator being punctured by iron particles to cause short circuit, thereby making a lithium ion battery including the separator have a low self-discharge rate, a good security and a good cycle performance.

In embodiments of the present disclosure, referring to FIG. 1, the porous layer 200 is disposed on one surface of the porous substrate 100. Therefore, on the premise that the separator meets usage requirements, materials are saved to a greatest extent, thereby reducing the production cost and the loss of energy density.

In embodiments of the present disclosure, referring to FIG. 2, the porous layer 200 is disposed on two surfaces of the porous substrate 100. Therefore, the lithium ion battery including this separator has a good thermal stability.

In embodiments of the present disclosure, the iron content in the porous layer 200 is equal to or less than 2100 ppm, thereby avoiding the porous substrate 100 of the separator being punctured by the iron particles to cause short circuit, and making the lithium ion battery including the separator have a low self-discharge rate, a good security and a good cycle performance.

Further, in embodiments of the present disclosure, the iron content in the porous layer 200 of the separator is equal to or less than 1000 ppm, thereby further avoiding the porous substrate 100 of the separator being punctured by the iron particles to cause short circuit, and making the lithium ion battery including the separator have a low self-discharge rate, a good security and a good cycle performance.

As described previously, the inventors found that, the excessive iron content in the porous layer 200 is mainly resulted from wear of the production equipment by inorganic particles with over-high hardness contained in the porous layer 200. In view of this, the present inventors propose to use inorganic particles with a Moh's hardness in a range of 0.5 to 8. In this way, the wear on the production equipment in the production process of the lithium ion battery can be reduced, such that the formation of the iron particles can be effectively reduced and thus the iron content in the separator is lowered, thereby avoiding the porous substrate 100 of the separator being punctured by the iron particles to cause short circuit, and making the lithium ion battery including the separator have a low self-discharge rate, an excellent security and cycle performance.

Further, in embodiments of the present disclosure, when the Moh's hardness of the inorganic particles is in a range of 1 to 4, it is substantially impossible to scratch the production equipment by the inorganic particles, because the Moh's hardness of this kind of inorganic particles is lower than that of the iron particles, and thus the formation of the iron particles may be reduced greatly. As compared with the case where aluminium oxide is used as the inorganic particles, the content of iron particles in the porous layer 200 of the separator has been reduced greatly, even as low as 130 ppm, thereby further avoiding the porous substrate 100 of the separator being punctured by the iron particles to cause short circuit, and making the lithium ion battery including the separator have a low self-discharge rate, an excellent security and cycle performance.

In embodiments of the present disclosure, material types of the inorganic particles are not specifically restricted, which can be flexibly selected by those skilled in the art as required. For example, the inorganic particles may include but are not limited to titanium dioxide, silica, magnesium oxide, boehmite, aluminum hydroxide, magnesium hydroxide and barium sulfate. In some embodiments of the present disclosure, the inorganic particles may be boehmite. In this way, the Moh's hardness of the inorganic particles is reduced greatly, which can effectively avoid the formation of the iron particles, and thus the content of the iron particles in the porous layer 200 of the separator is low, thereby further avoiding the porous substrate 100 of the separator being punctured by the iron particles to cause short circuit, and making the lithium ion battery including the separator have a low self-discharge rate, an excellent security and cycle performance. In addition, these types of inorganic particles not only have extensive sources, but are cheap and easily available.

In embodiments of the present disclosure, the porous layer 200 further includes the binder. The material types of the binder are not specifically restricted herein, and can be flexibly selected by those skilled in the art as required. For example, the binder includes but is not limited to polyamide, polyacrylonitrile, polyacrylic ester, polyacrylic acid, polyacrylate, carboxymethylcellulose sodium, aramid fiber, polyvinylpyrrolidone, polyvinylidene fluoride, polytetrafluoroethylene, polyhexafluoropropylene, vinylidene fluoride-hexafluoropropylene copolymer, acrylic acid-acrylate copolymer, epoxy resin, polyurethane, polyvinylether, and styrene butadiene rubber. In some embodiments of the present disclosure, the binder may be polyacrylic ester. These binders have good compatibility with the inorganic particles, a slurry prepared therefrom has a good dispersibility, and the inorganic particles will not agglomerate, which will not result in the wear of the production equipment, and thus the content of the iron particles in the separator is low, thereby further avoiding the porous substrate 100 of the separator being punctured by the iron particles to cause short circuit, and making the lithium ion battery including the separator have a low self-discharge rate, an excellent security and cycle performance. In addition, these binders not only have extensive sources, but are cheap and easily available.

Furthermore, the inventors have carried out intensive investigation and experimental verification on a mass percentage of the inorganic particles, and found that when the mass percentage of the inorganic particles is controlled to 40 wt % to 99.9 wt % of a total mass of the porous layer 200, the formation of the iron particles can be effectively avoided, and the content of the iron particles in the separator will be low. Further, in embodiments of the present disclosure, based on the total mass of the porous layer 200, the mass percentage of the inorganic particles is in a range of 50 wt % to 90 wt %, which is moderate, neither too high so that the friction frequency between the inorganic particles and the production equipment increases and the content of the iron particles increases, nor too low so that the heat shrinkage of the separator cannot be better inhibited at high temperature, leading to deterioration of the security of the lithium ion battery including the separator. In addition, the content of the binder is also moderate, which is neither too high so that the cycle performance of the battery including the separator is deteriorated, nor too low so that an adhesive force of the porous layer 200 is too weak, and the porous layer 200 can be easily stripped from the surface of the separator under an external force, thereby cannot playing a protecting effect. In some embodiments of the present disclosure, the mass percentage of the inorganic particles may be 40 wt %, 50 wt %, 60 wt %, 70 wt %, 80 wt %, 90 wt %, 99 wt %, or 99.9 wt %. When the mass percentage of the inorganic particles is 90 wt %, the security and cycle performance of the lithium ion battery including the separator is optimum.

Further, the inventors have carried out intensive investigation and experimental verification on a thickness of the porous layer 200, and found that when the thickness of the porous layer 200 is in a range of 0.1 to 12 μm, the formation of the iron particles can be effectively avoided, and the content of the iron particles in the separator will be low. Further, in embodiments of the present disclosure, the thickness of the porous layer 200 is in a range of 0.5 to 10 μm, which is moderate, neither too thin so that the protecting effect on the porous substrate cannot be better played, leading to deterioration of the security of the lithium ion battery including the separator, nor too thick so that the wear frequency of the production equipment increases and the content of the iron particles increases significantly, leading to deterioration of the security and cycle performance of the lithium ion battery including the separator. In embodiments of the present disclosure, the thickness of the porous layer 200 may be 0.1 μm, 2 μm, 4 μm, 6 μm, 8 μm, 10 μm or 12 μm, in which the thickness of 4 μm makes the security and cycle performance better.

In the present disclosure, material types of the porous substrate 100 are not specifically restricted, and can be flexibly selected by those skilled in the art as required. For example, the porous substrate 100 may include but is not limited to polyethylene (PE), polypropylene (PP), polyethylene terephthalate (PET), polyimide (PI) and aramid fiber. In embodiments of the present disclosure, the porous substrate 100 may be PE. Therefore, materials of the porous substrate not only have extensive sources, but are cheap and easily available.

In embodiments of the present disclosure, a thickness of the porous substrate 100 is not specifically restricted, and can be flexibly selected by those skilled in the art as required. In embodiments of the present disclosure, the thickness of the porous substrate 100 may be in a range of 1 to 30 μm, which is moderate, neither too thin so that the separator is prone to rupture, nor too thick, leading to a loss of the energy density of the lithium ion battery.

In embodiments of a second aspect of the present disclosure, a lithium ion battery is provided, which includes the separator as described above. The inventors found that, the lithium ion battery has a low self-discharge rate, an excellent security and cycle performance, and possesses all the characteristics and advantages of the separator as described above, which will not be elaborated herein.

In embodiments of the present disclosure, the lithium ion battery has a general structure of a lithium-ion battery in the related art, for example, including a positive electrode, a negative electrode, an electrolyte, etc.

In embodiments of the present disclosure, the positive electrode includes a positive material, and the positive material includes a lithium (Li) intercalatable/deintercalatable positive material (capable of receiving/releasing Li, also known as “Li intercalation/deintercalation positive material”). In embodiments of the present disclosure, examples of the Li intercalation/deintercalation positive material may include lithium cobaltate, lithium nickel cobalt manganite composite oxide, lithium nickel cobalt aluminate composite oxide, lithium manganese oxide, lithium manganese ferric phosphate, lithium vanadium phosphate, lithium vanadium phosphate composite oxide, lithium iron phosphate, lithium titanate and Li-riched manganese base material.

Lithium cobaltate may have a chemical formula (I) shown below:

LiₓCoₐM1_{b}O_{2-c} (I),

wherein M1 represents at least one selected from the group of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), stannum (Sn), calcium (Ca), strontium (Sr), wolfram (W), zirconium (Zr), and silicon (Si), 0.8≤x≤1.2, 0.8≤a≤1, 0≤b≤0.2, and −0.1≤c≤0.2.

Lithium nickel cobalt manganite composite oxide or lithium nickel cobalt aluminate composite oxide may have a chemical formula (II) shown below:

Li_{y}Ni_{d}M2ₑO_{2-f} (II),

wherein M2 represents at least one selected from the group of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), stannum (Sn), calcium (Ca), strontium (Sr), wolfram (W), zirconium (Zr) and silicon (Si), 0.8≤y≤1.2, 0.3≤d≤0.98, 0.02≤e≤0.7, and −0.1≤f≤0.2.

Lithium manganese oxide may have a chemical formula (III) shown below:

Li_{z}Mn_{2-g}M_{3g}O₄₋ₕ (III),

wherein M3 represents at least one selected from the group of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), stannum (Sn), calcium (Ca), strontium (Sr) and wolfram (W), 0.8≤z≤1.2, 0≤g≤1.0, and −0.2≤h≤0.2.

In embodiments of the present disclosure, the negative electrode includes a negative material, and negative material includes a Li intercalatable/deintercalatable negative material (capable of receiving/releasing Li, also known as “Li intercalation/deintercalation negative material”). In embodiments of the present disclosure, the Li intercalation/deintercalation negative material may include carbon materials, metallic compounds, oxides, sulfides, lithium nitrides (e.g., LiN₃), lithium metal, metals that can form an alloy with lithium or polymer materials.

In embodiments of the present disclosure, the carbon materials may include low-graphitized carbons, graphitizable carbons, artificial graphite, natural graphite, mesocarbon microbeads, soft carbons, hard carbons, pyrolytic carbons, cokes, glass carbons, sintered body of an organic polymer compound, carbon fibers and activated carbons. Cokes may include pitch cokes, needle cokes and petroleum cokes. Sintered body of the organic polymer compound refers to such a material that is obtained by carbonization of a polymer material, such as a phenol plastic or a furan resin, through calcining at an appropriate temperature, and some of these materials are divided into the low-graphitized carbons and the graphitizable carbons. Polymer materials may include polyacetylene and polypyrrole.

Further, among the Li intercalation/deintercalation negative materials, a material with charge and discharge voltages close to that of the lithium metal is further selected, this is because the lower the charge and discharge voltages of the negative material are, the easier it is for a battery to have a higher energy density. In embodiments of the present disclosure, the carbon material may be selected as the negative material, because only small changes occur in the crystal structure thereof when charging and discharging, so that good cycle characteristic and large charging and discharging capacities can be achieved. Especially, the graphite may be selected as the negative material, because it can give a large electrochemical equivalence and a high energy density.

The Li intercalation/deintercalation negative material may include lithium elementary substance, metallic and semimetallic elements capable of forming an alloy with Li, and alloys and compounds including these metallic and semimetallic elements. In particular, these materials are used together with the carbon material, as in such a case, good cycle characteristic and high energy density can be achieved. In addition to an alloy including two or more metallic elements, the alloy used herein further includes such an alloy that includes one or more metallic elements and one or more semimetallic elements. This alloy may be in a state of solid solution, eutectic crystal (eutectic mixture), intermetallic compound and a mixture thereof.

The metallic elements and semimetallic elements (also known as amphoteric elements) may include stannum (Sn), plumbum (Pb), aluminum (Al), indium (In), silicon (Si), zinc (Zn), stibium (Sb), bismuth (Bi), cadmium (Cd), magnesium (Mg), boron (B), gallium (Ga), germanium (Ge), arsenic (As), argentum (Ag), zirconium (Zr), yttrium (Y), and hafnium (Hf). Examples of the alloy and compound as described above may include a material having a chemical formula of MaₛMbₜLiᵤ and a material having a chemical formula of MaₚMc_{q}Mdᵣ. In these chemical formulas, Ma represents at least one of the metallic and semimetallic elements capable of forming the alloy with lithium; Mb represents at least one of the metallic and semimetallic elements except lithium and Ma; Mc represents at least one of nonmetallic elements; Md represents at least one of the metallic and semimetallic elements except Ma; and s>0, t≥0, u≥0, p>0, q>0 and r≥0. In addition, inorganic compounds not including Li, such as MnO₂, V₂O₅, V₆O₁₃, NiS or MoS, may be used in the negative material.

The electrolyte includes a lithium salt and a non-aqueous solvent. The lithium salt includes at least one selected from the group of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, LiBOB, LiBr and lithium difluoroborate. For example, LiPF₆ may be selected as the lithium salt, because it can give a high ionic conductivity and improve the cycle characteristic.

The non-aqueous solvent may be a carbonate based compound, an ester-based compound, an ether-based compound, a koto-based compound, an alcohol-based compound, an aprotic solvent, or a combination thereof.

The carbonate based compound may include a linear carbonate compound, a cyclic carbonate compound, a fluoro-substituted carbonate compound, or a combination thereof.

Examples of the linear carbonate compound include diethyl carbonate (DEC), dimethyl carbonate (DMC), dipropyl carbonate (DPC), methyl propyl carbonate (MPC), ethyl propyl carbonate (EPC), methyl ethyl carbonate (MEC), and a combination thereof. Examples of the cyclic carbonate compound include ethylene carbonate (EC), propylene carbonate (PC), butylene carbonate (BC), vinyl ethylene carbonate (VEC), and a combination thereof. Examples of the fluoro-substituted carbonate compound include fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, and a combination thereof.

Examples of the ester-based compound include methyl acetate, ethyl acetate, n-propyl acetate, tert-butyl acetate, methyl propionate, ethyl propionate, γ-butyrolactone, decalactone, valerolactone, DL-mevalonic acid lactone, caprolactone, methyl formate, and a combination thereof.

Examples of the ether-based compound include dibutyl ether, tetraethylene glycol dimethyl ether, diethylene glycol dimethyl ether (diglyme), 1,2-dimethoxyethane, 1,2-diethoxyethane, ethoxy-methoxy ethane, 2-methyltetrahydrofuran, tetrahydrofuran, and a combination thereof.

Example of the koto-based compound includes cyclohexanone.

Examples of the alcohol-based compound include an ethanol and isopropanol.

Examples of the aprotic solvent include dimethylsulfoxide, 1,3-dioxolane, sulfolane, methylsulfolane, 1,3-dimethyl-2-imidazolidinone, N-methyl-2-pyrrolidone, formamide, dimethylformamide, acetonitrile, nitromethane, trimethyl phosphate, triethyl phosphate, trioctyl phosphate, phosphate, and a combination thereof.

In embodiments of the present disclosure, the positive electrode, the separator and the negative electrode are wound or stacked in sequence into a cell, and then put into an aluminum plastic film, followed by the injection of the electrolyte, formation, encapsulation to form the lithium ion battery. Afterwards, performances of the lithium ion battery produced thereby are tested.

It will be appreciated to those skilled in the art that, the above-described method for producing a lithium ion battery is only illustrative, and other conventional methods in the related art can be applied without departing from spirit, principles and scope of the present disclosure.

The separator according to embodiments of the present disclosure may be used in lithium ion batteries with different structures. Though a wound-type lithium ion battery is used as an example of the present disclosure, the separator of the present disclosure can be used in a lithium ion battery with a laminated structure or a multi-tab structure, all of which are included in the scope of the present disclosure.

The separator according to embodiments of the present disclosure can be used in different types of lithium ion batteries. Though a pouch-type lithium ion battery is used as an example of the present disclosure, the separator of the present disclosure can be used in other types of lithium ion batteries like a prismatic battery, a cylindrical battery, etc., all of which are included in the scope of the present disclosure.

In the following, examples of the present disclosure will be described in detail.

The lithium ion batteries in examples 1-26 and comparative example 1 all are produced in accordance with the following method.

### Preparation of the Positive Electrode:

Lithium cobaltate active component, acetylene black conductive agent, and polyvinylidene fluoride (PVDF) binder in a weight ratio of 94:3:3 were homogeneously mixed in N-methyl pyrrolidone solvent system under stirring, and then coated onto an aluminum foil, followed by drying, pressing, and cutting to obtain the positive electrode.

Preparation of the Negative Electrode:

Artificial graphite active component, acetylene black conductive agent, styrene butadiene rubber (SBR) binder, and carboxymethylcellulose sodium (CMC) thickener in a weight ratio of 95:2:2:1 were homogeneously mixed in deionized water solvent system under stirring, and then coated onto a copper foil, followed by drying, pressing, and cutting to obtain the negative electrode.

### Preparation of Electrolyte:

In an argon atmosphere glove box with a water content less than 10 ppm, ethylene carbonate (EC), propylene carbonate (PC) and diethyl carbonate (DEC) were mixed in a volume ratio of EC:PC:DEC=1:1:1, and then fully dried lithium hexafluorophosphate was dissolved in and homogeneously mixed with the mixed organic solvent to obtain the liquid electrolyte.

### Preparation of Separator:

Inorganic particles and the binder in a certain mass ratio were added to and homogeneously mixed with deionized water under stirring to form a slurry, which was then evenly coated onto one surface or both surfaces of a polyethylene (PE) substrate having a thickness of 7 μm through a microgravure coating method and dried in an oven to obtain a composite porous separator.

The composite porous separator subjected to the above coating treatment was used as the separator.

### Preparation of Lithium Ion Battery:

The positive electrode, the separator and the negative electrode were stacked in that order and wound to obtain a cell where the separator is arranged between the positive electrode and the negative electrode to play an isolation effect. Afterwards, the cell was placed in an outer packing foil and dried to remove water, then the ready formulated electrolyte as described above was injected, flowed by vacuum packaging, standing, formation, and shaping processes to obtain the lithium ion battery.

### Example 1

The lithium ion battery was produced in accordance with the method as described above. Boehmite inorganic particles (Moh's hardness in a range from 3 to 3.5) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 2

The lithium ion battery was produced in accordance with the method as described above. Magnesium hydroxide inorganic particles (Moh's hardness in a range from 1.5 to 2) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 3

The lithium ion battery was produced in accordance with the method as described above. Aluminum hydroxide inorganic particles (Moh's hardness of 3) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 4

The lithium ion battery was produced in accordance with the method as described above. Barium sulfate inorganic particles (Moh's hardness in a range from 3 to 4) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Comparative Example 1

The lithium ion battery was produced in accordance with the method as described above. Aluminium oxide inorganic particles (Moh's hardness of 9) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 5

The lithium ion battery was produced in accordance with the method as described above. Boehmite inorganic particles (Moh's hardness in a range from 3 to 3.5) and polyacrylic ester binder in a mass ratio of 50:50 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 6

The lithium ion battery was produced in accordance with the method as described above. Boehmite inorganic particles (Moh's hardness in a range from 3 to 3.5) and polyacrylic ester binder in a mass ratio of 60:40 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 7

The lithium ion battery was produced in accordance with the method as described above. Boehmite inorganic particles (Moh's hardness in a range from 3 to 3.5) and polyacrylic ester binder in a mass ratio of 70:30 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 8

The lithium ion battery was produced in accordance with the method as described above. Boehmite inorganic particles (Moh's hardness in a range from 3 to 3.5) and polyacrylic ester binder in a mass ratio of 80:20 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 9

The lithium ion battery was produced in accordance with the method as described above. Boehmite inorganic particles (Moh's hardness in a range from 3 to 3.5) and polyacrylic ester binder in a mass ratio of 99:1 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 10

The lithium ion battery was produced in accordance with the method as described above. Boehmite inorganic particles (Moh's hardness in a range from 3 to 3.5) and polyacrylic ester binder in a mass ratio of 40:60 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 11

The lithium ion battery was produced in accordance with the method as described above. Boehmite inorganic particles (Moh's hardness in a range from 3 to 3.5) and polyacrylic ester binder in a mass ratio of 99.9:0.1 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 12

The lithium ion battery was produced in accordance with the method as described above. Boehmite inorganic particles (Moh's hardness in a range from 3 to 3.5) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 0.5 μm.

### Example 13

The lithium ion battery was produced in accordance with the method as described above. Boehmite inorganic particles (Moh's hardness in a range from 3 to 3.5) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 2 μm.

### Example 14

The lithium ion battery was produced in accordance with the method as described above. Boehmite inorganic particles (Moh's hardness in a range from 3 to 3.5) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 6 μm.

### Example 15

The lithium ion battery was produced in accordance with the method as described above. Boehmite inorganic particles (Moh's hardness in a range from 3 to 3.5) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 8 μm.

### Example 16

The lithium ion battery was produced in accordance with the method as described above. Boehmite inorganic particles (Moh's hardness in a range from 3 to 3.5) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 10 μm.

### Example 17

The lithium ion battery was produced in accordance with the method as described above. Boehmite inorganic particles (Moh's hardness in a range from 3 to 3.5) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 0.1 μm.

### Example 18

The lithium ion battery was produced in accordance with the method as described above. Boehmite inorganic particles (Moh's hardness in a range from 3 to 3.5) and polyacrylic ester binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 12 μm.

### Example 19

The lithium ion battery was produced in accordance with the method as described above. Boehmite inorganic particles (Moh's hardness in a range from 3 to 3.5) and polyvinylidene fluoride binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 20

The lithium ion battery was produced in accordance with the method as described above. Boehmite inorganic particles (Moh's hardness in a range from 3 to 3.5) and pure acrylic emulsion (acrylic acid-acrylate copolymer) binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 21

The lithium ion battery was produced in accordance with the method as described above. Boehmite inorganic particles (Moh's hardness in a range from 3 to 3.5) and polyamid binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 22

The lithium ion battery was produced in accordance with the method as described above. Boehmite inorganic particles (Moh's hardness in a range from 3 to 3.5) and polyacrylic acid binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 23

The lithium ion battery was produced in accordance with the method as described above. Boehmite inorganic particles (Moh's hardness in a range from 3 to 3.5) and carboxymethylcellulose sodium binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 24

The lithium ion battery was produced in accordance with the method as described above. Boehmite inorganic particles (Moh's hardness in a range from 3 to 3.5) and styrene butadiene rubber binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 25

The lithium ion battery was produced in accordance with the method as described above. Boehmite inorganic particles (Moh's hardness in a range from 3 to 3.5) and epoxy resin binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

### Example 26

The lithium ion battery was produced in accordance with the method as described above. Boehmite inorganic particles (Moh's hardness in a range from 3 to 3.5) and polyurethane binder in a mass ratio of 90:10 were added to and homogeneously mixed with deionized water to form a slurry, which was then evenly coated onto one surface of a PE substrate having a thickness of 7 μm through the microgravure coating method and dried in an oven to obtain a composite porous separator. A thickness of the coating layer after dried was 4 μm.

Test Method:

1. Test of Iron Content in the Porous Layer of the Separator

The lithium ion battery was disassembled, 0.2 g separator containing the porous layer was taken from the disassembled lithium ion battery and put into an aqua regia solution (10 ml), which was then subjected to a microwave digestion, and filtered to remove insoluble substances, the filtrate was brought to a constant volume (50 ml) with ultrapure water, and then tested by an inductively coupled plasma emission spectrometer (ICP-OES) to obtain the iron content.

Test results are shown in Table 1.

2. Self-Discharge Test of Lithium Ion Battery

At room temperature, the lithium ion battery was charged at a constant current of 0.5 C (C-rate) to a voltage of 3.85 V, and further charged at a constant voltage of 3.85 V to a current of 0.05 C. For each lithium ion battery, an initial voltage was tested and recorded as V1 (mV), after left for a certain period of time t (h) at the room temperature, a final voltage was tested and recorded as V2 (mV). The self-discharge value was obtained according to the following formula:

Self-discharge of the lithium ion battery=(V1−V2)/t (mV/h)

Test results are shown in Table 1.

3. Nail Test of the Lithium Ion Battery

At room temperature, the lithium ion battery was charged at a constant current of 0.5 C to a voltage higher than 4.4 V, and further charged at a constant voltage of 4.4 V until a current below 0.05 C, to make the battery reach a full charge state of 4.4 V. The battery was subjected to the nail test with a 4 mm nail at a speed of 50 mm/s to observe whether the smoke, fire or explosion occurred, if no, it was determined that the lithium ion battery passed the nail test. For each of comparative examples and examples, 10 batteries were tested.

Test results are shown in Table 1.

4. Cycle Performance Test of Lithium Ion Battery

At 25° C., the lithium ion battery was charged at a constant current of 0.7 C to a voltage of 4.4 V and further charged at a constant voltage of 4.4 V until a current below 0.05 C, and then discharged at a constant current of 0.5 C to a voltage of 3 V, this was the first cycle of the lithium ion battery, and a discharge capacity of the first cycle was recorded. 200 charging-discharging cycles were performed in accordance with the above-mentioned method, and a 200^{th} discharge capacity was recorded.

The capacity retention rate of the lithium ion battery after 200 cycles=(200^{th} discharge capacity/1^{st} discharge capacity)×100%.

For each of comparative examples and examples, five batteries were tested, and their average capacity retention rate was calculated. The results are shown in Table 1.

TABLE 1
Results of iron content in porous layer of the separator, self-discharge
test, nail test and cycle performance test of the lithium ion battery

| | | Self-discharge | | |
|---|---|---|---|---|
| | Fe content | value of | Nail test | Capacity retention |
| | in porous | lithium ion | (passing | rate of lithium ion |
| | layer | battery | times/total | battery after 200 |
| | (ppm) | (mV/h) | test times) | cycles at 25° C. |
| Example 1 | 672 | 0.032 | 9/10 | 90.9% |
| Example 2 | 130 | 0.019 | 10/10 | 92.3% |
| Example 3 | 457 | 0.028 | 9/10 | 91.9% |
| Example 4 | 898 | 0.047 | 7/10 | 90.3% |
| Comparative | 3570 | 0.16 | 0/10 | 82.2% |
| Example 1 | | | | |
| Example 5 | 355 | 0.016 | 7/10 | 90.0% |
| Example 6 | 421 | 0.021 | 7/10 | 90.2% |
| Example 7 | 477 | 0.026 | 8/10 | 90.6% |
| Example 8 | 502 | 0.029 | 8/10 | 90.5% |
| Example 9 | 887 | 0.04 | 8/10 | 90.1% |
| Example 10 | 306 | 0.015 | 2/10 | 80.9% |
| Example 11 | 1158 | 0.09 | 3/10 | 84.1% |
| Example 12 | 304 | 0.045 | 7/10 | 90.1% |
| Example 13 | 561 | 0.03 | 8/10 | 91.1% |
| Example 14 | 816 | 0.026 | 8/10 | 90.5% |
| Example 15 | 906 | 0.021 | 9/10 | 90.1% |
| Example 16 | 978 | 0.023 | 9/10 | 90.0% |
| Example 17 | 490 | 0.13 | 2/10 | 80.2% |
| Example 18 | 1842 | 0.04 | 3/10 | 77.5% |
| Example 19 | 780 | 0.04 | 9/10 | 90.8% |
| Example 20 | 602 | 0.029 | 8/10 | 90.4% |
| Example 21 | 559 | 0.026 | 9/10 | 90.1% |
| Example 22 | 904 | 0.05 | 7/10 | 91.8% |
| Example 23 | 872 | 0.047 | 7/10 | 90.6% |
| Example 24 | 991 | 0.055 | 7/10 | 90.1% |
| Example 25 | 2057 | 0.13 | 2/10 | 65.6% |
| Example 26 | 1769 | 0.12 | 3/10 | 70.2% |

It can be seen from the analysis of examples 1-4 and comparative example 1 that, the selection of inorganic particles with low Moh's hardness in a range of 1 to 4 can effectively avoid the formation of the iron particles, such that the content of iron particles in the porous layer of the separator is low, thereby further avoiding the porous substrate of the separator being punctured by the iron particles to cause short circuit, and making the lithium ion battery including the separator have a low self-discharge rate, an excellent security and cycle performance.

It can be seen from the analysis of examples 1 and 5-11 that, by controlling the mass percentage of the inorganic particles to 40 wt % to 99.9 wt % of the total mass of the porous layer 200, the formation of the iron particles can be effectively avoided, and thus the content of iron particles in the separator is low. Further, when the inorganic particles account for 90 wt % of the total mass of the porous layer 200, both the security and the cycle performance of the lithium ion battery including this separator are optimum.

It can be seen from the analysis of examples 1 and 12-18 that, when the thickness of the porous layer is in a range of 0.1 to 12 μm, the formation of the iron particles can be effectively avoided, and thus the content of iron particles in the separator is low. Further, when the thickness of the porous layer is in a range of 2 to 10 μm, both the security and the cycle performance of the lithium ion battery including this separator are optimum.

It can be seen from the analysis of examples 1 and 19-26 that, the selection of polyacrylic ester, polyvinylidene fluoride, aramid fiber, polyacrylic acid, carboxymethylcellulose sodium, styrene butadiene rubber, acrylic acid-acrylate copolymer, epoxy resin or polyurethane as the binder can effectively avoid the formation of the iron particles, and thus the content of iron particles in the separator is low. Further, the selection of polyacrylic ester, polyvinylidene fluoride or aramid fiber as the binder allows both the security and the cycle performance of the lithium ion battery including this separator to reach an optimum value.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, in the absence of contradiction, those skilled in the art can combine the different embodiments or examples described in this specification, or combine the features of different embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A separator, comprising:
a porous substrate; and
a porous layer, disposed on at least one surface of the porous substrate,
wherein an iron content in the porous layer is not more than 2100 ppm.

2. The separator according to claim 1, wherein the iron content in the porous layer is not more than 1000 ppm.

3. The separator according to claim 1, wherein the porous layer comprises inorganic particles and a binder, and the inorganic particles have a Moh's hardness of 0.5 to 8.

4. The separator according to claim 3, wherein the inorganic particles comprise one or more selected from titanium dioxide, silica, magnesium oxide, boehmite, aluminum hydroxide, magnesium hydroxide and barium sulfate.

5. The separator according to claim 3, wherein the binder comprises one or more selected from the group of polyamide, polyacrylonitrile, polyacrylic ester, polyacrylic acid, polyacrylate, carboxymethylcellulose sodium, aramid fiber, polyvinylpyrrolidone, polyvinylidene fluoride, polytetrafluoroethylene, polyhexafluoropropylene, vinylidene fluoride-hexafluoropropylene copolymer, acrylic acid-acrylate copolymer, epoxy resin, polyurethane, polyvinylether and styrene butadiene rubber.

6. The separator according to claim 3, wherein based on a total mass of the porous layer, a mass percent of the inorganic particles is in a range of 40 wt % to 99.9 wt %.

7. The separator according to claim 1, wherein the porous layer has a thickness of 0.1 to 12 μm.

8. The separator according to claim 1, wherein the porous substrate comprises one or more selected from the group of polyethylene, polypropylene, polyethylene terephthalate, polyimide and aramid fiber.

9. The separator according to claim 1, wherein the porous substrate has a thickness of 1 to 30 μm.

10. The separator according to claim 3, wherein the inorganic particles have a Moh's hardness of 1 to 4.

11. The separator according to claim 6, wherein based on the total mass of the porous layer, the mass percent of the inorganic particles is in a range of 50 wt % to 90 wt %.

12. A lithium ion battery, comprising a separator, wherein the separator comprises:
a porous substrate; and
a porous layer, disposed on at least one surface of the porous substrate,
wherein an iron content in the porous layer is not more than 2100 ppm.

13. The lithium ion battery according to claim 12, wherein the iron content in the porous layer is not more than 1000 ppm.

14. The lithium ion battery according to claim 12, wherein the porous layer comprises inorganic particles and a binder, and the inorganic particles have a Moh's hardness of 0.5 to 8.

15. The lithium ion battery according to claim 14, wherein the inorganic particles comprise one or more selected from titanium dioxide, silica, magnesium oxide, boehmite, aluminum hydroxide, magnesium hydroxide and barium sulfate.

16. The lithium ion battery according to claim 14, wherein the binder comprises one or more selected from the group of polyamide, polyacrylonitrile, polyacrylic ester, polyacrylic acid, polyacrylate, carboxymethylcellulose sodium, aramid fiber, polyvinylpyrrolidone, polyvinylidene fluoride, polytetrafluoroethylene, polyhexafluoropropylene, vinylidene fluoride-hexafluoropropylene copolymer, acrylic acid-acrylate copolymer, epoxy resin, polyurethane, polyvinylether and styrene butadiene rubber.

17. The lithium ion battery according to claim 14, wherein based on a total mass of the porous layer, a mass percent of the inorganic particles is in a range of 40 wt % to 99.9 wt %.

18. The lithium ion battery according to claim 12, wherein the porous layer has a thickness of 0.1 to 12 μm.

19. The lithium ion battery according to claim 12, wherein the porous substrate comprises one or more selected from the group of polyethylene, polypropylene, polyethylene terephthalate, polyimide and aramid fiber.

20. The lithium ion battery according to claim 12, wherein the porous substrate has a thickness of 1 to 30 μm.
